(19) United States
(12) Patent Application Publication
(10) Pub. No.: US 2017/0251734 A1
(43) Pub. Date: Sep. 7, 2017

(54) AN ABRASION RESISTANT MATERIAL AND METHOD OF CONSTRUCTION

(71) Applicant: Becon Pty Ltd, Port Melbourne (AU)

(72) Inventors: Christopher HURREN, Port Melbourne (AU); Grant MACKINTOSH, Port Melbourne (AU)

(73) Assignee: Becon Pty Ltd, Port Melbourne (AU)

(21) Appl. No.: 15/515,872

(22) PCT Filed: Sep. 30, 2015
(86) PCT No.: PCT/AU2015/000593

§ 371 Date: Mar. 30, 2017

(30) Foreign Application Priority Data
Sep. 30, 2014 (AU) 2014903890

(51) Int. Cl. A41D 13/00; B32B 27/12; B32B 5/26; B32B 7/12; B32B 5/02; B32B 5/06

(52) U.S. Cl. CPC A41D 13/0002; B32B 5/022; B32B 5/024; B32B 5/026; B32B 5/06; B32B 5/26; B32B 7/12; B32B 27/12; B32B 2262/0269; B32B 2307/554; B32B 2307/724; B32B 2307/726; B32B 2437/00; B32B 2307/718; B32B 2262/062; B32B 2307/5825; B32B 2307/54

(57) ABSTRACT

An abrasion resistant material for use in the fabrication of protective garments that has at least two layers, a first layer and a second layer, wherein the first layer is the layer that is exposed to and engages with the abrasive surface, such as a road surface. The second layer comprises of substantially high tensile and burst strength so as to act as a protective layer which covers or is at least located closest to the skin of the wearer. The first layer has a plurality of abrasion resistant members dispersed throughout the first layer that act to absorb the bulk of any abrasion force and reduce the exposure and degradation of the second layer

### FIELD OF THE INVENTION

The present invention relates to abrasion resistant material and method of manufacture, in particular abrasion resistant material suitable but not solely for the manufacture of protective garments and apparel for motorcycle and bicycle riders. Accordingly, wherein riders are exposed to abrasion with a moving surface, such as a road surface during a crash, the abrasion resistant material possesses sufficient abrasion, burst and tear resistance so as to retain structural integrity to protect the rider from significant injury.

### DESCRIPTION OF THE PRIOR ART

The common risk faced by motorcyclists, cyclists, skating and skateboarding and other similar activities, is injury from sliding after a a fall or crash, whereby in addition to the intial impact, the individual is then exposed to an abrasive surface and force. The severity of abrasion injuries can be quite significant depending upon the length of time and speed at which the rider is exposed to the moving surface.

For example, a motorcycle rider falling at a moderate speed can still experience severe injury from abrasion wherein not only skin but flesh, muscle and even bone may be abraded. Abrasion injuries can be particularly painful, susceptible to infection and are often slow healing.

Accordingly, various forms of abrasion protection clothing and apparel exist to attempt to improve wearer safety and prevent serious abrasive injury.

The resistance to the initial impact plays a large part in the failure of any abrasion protection garment. When the rider hits the road, it pushes the material of the garment into the road surface, causing a significant and rapidly applied load. If the material or seam of the protective garment fails at this point then the body of the rider will instantly be subjected to road surface resulting in an abrasion injury. The burst strength on impact is often thought of by manufacturers for seam strength in respect of a garment but is not considered within the fabric layer system itself. For a protective layer to be made thinner it must possess good resistance to abrasion but also must not fail during the initial impact event.

Accordingly, due to the difficulty in manufacturung suitably strong yet thin materials and garments, many existing abrasion materials and products are formed of densely constructed or thickly layered materials. For example, thick leather is often used as it provides greater abrasion resistance compared to that of conventional cloth materials and textiles. Some products incorporate synthetic materials such as nylon, Kevlar™ or Gortex™, or combinations thereof to increase the abrasion resistance of the material or garment formed thereafter.

However, there are a number of drawbacks with these conventional abrasion resistant materials. Firstly, the use of densely woven or thickly layered materials can consequently increasing the weight of the material and the garment that is formed from the material. Whilst leather is widely used as an abrasion resistant material, it can be particularly heavy and uncomfortable to wear.

Thickly layered materials are designed so as to provide redundancy as outer layers abrade away when exposed to an abrasive surface or fall. But again these materials can be quite weighty. Further, if some or all of the outer layers are abraded, the underlying layer or layers are then exposed to the abrasive surface and the overall structural integrity of the material can fail providing minimal protection to the rider.

Additionally, the thick and heavy materials can also restrict the movement of the wearer.

Another particular shortcoming of densely woven or thickly layered materials is the permeability and breathability of the materials. Poor ventilation, particularly during warm weather, generates heat and sweat within the garment and can cause significant discomfort to the wearer.

### OBJECT OF THE INVENTION

It is an object of the present invention to provide an abrasion resistant material with improved abrasion, burst and tear resistance, comparied to that of existing materials and textiles used in the manufacture of protective garments and apparel.

Abrasion of a material or textile structure when in contact with a moving surface, is controlled by three key parameters. The first being the amount of material that is in contact with the abrasive surface at any one time, the second is the ability for the material structure to partially abrade without significantly reducing the burst or tear strength of the material and the third is the ability of the material to resist bursting or tearing during contact with the abrasive surface.

The contact that a material structure makes with an abrasion surface is crucial as the manner of interaction between the material and the abrasion surface will help to distribute abrasion load controlling abrasion failure rate.

The abrasion resistant material of the present invention is constructed of at least two layers: a first layer being an abrasion layer which is exposed to an abrasive surface and force and a second layer being an underlying protecting layer.

The first layer is the outermost layer and plays a significant role wherein the interaction of the first layer with the abrasive surface enables the first layer to distribute the bulk of the abrasive load and reduce the exposure of the second layer to the abrasive surface. Accordingly, the first layer in combination with the second layer, assists to increase the resistance of the overall abrasion resistant material to tensile and burst failure.

The first and second layers of the abrasion resistant material are formed of fibres or yarns that are arranged in a manner so as to maximise the exposure and interaction of the first layer with the abrasive surface such as a road surface, and absorb the abrasive energy without suffering from bursting, tearing or structural failure of the second layer.

Accordingly, the structural integrity of the abrasion resistant material, and the garment or apparel formed of the abrasion resistant material, is maintained during the abrasion and assists to protect the wearer from significant abrasive injury.

The two layer effect of the abrasion resistant material can be achieved through a physical connection or attachment of the first and second layers, such as but not limited to lamination, gluing, stitch bonding and knit or weave structure.

Additionally, the construction of the abrasion resistant material of the present invention also assists to make it lightweight. This increases the comfort to the wearer/rider and also increases the versatlilty of the abrasion resistant material in the manufacture of a variety of garments and apparel.

Further, the construction of the abrasion resistant material assists to effectively manage moisture retention and ventiliation.

Other objects and advantages of the present invention will become apparent from the following description, taking in connection with the accompanying drawings, wherein, by way of illustration and example, an embodiment of the present invention is disclosed.

### SUMMARY OF THE INVENTION

According to the present invention, although this should not be seen as limiting the invention in any way, there is provided an abrasion resistant material for use in the fabrication of protective apparel comprising:
at least a first layer;
a plurality of abrasion members dispersed throughout the first layer;
at least a second layer underlying the first layer, the second layer having substantially high tensile and burst strength;
   wherein the abrasion resistant material is exposed to an abrasive surface and force, the plurality of abrasion members of the first layer are adapted to engage with the abrasive surface and absorb the abrasive force, thereby minimizing exposure of the second layer to the abrasive surface and force and increasing resistance of the abrasion resistant material to tensile or burst failure.

Preferably, the plurality of abrasion members protrude beyond a substantially flat plane of the first layer.

Preferably, the plurality of abrasion members comprise of a plurality of fibres dispersed throughout the first layer.

Preferably, the plurality of abrasion members comprise of fibres selected from the group consisting of woven fibres, non-woven fibres, looped fibres, knitted fibres and combinations thereof.

Preferably, the looped fibers are terry looped fibers.

Preferably, the first layer is interconnected with the second layer.

Preferably, the first layer is interconnected with the second layer by a woven means comprising at least one interlocking thread passing through both the first and second layers.

Preferably, the first and second layers are interconnected by an adhesive means.

Preferably, the first and second layers are chemically bonded.

Preferably, the first and second layer are thermally bonded.

Preferably, the first layer comprises of a flexible textile material.

Preferably, the second layer comprises of a flexible textile material.

Preferably, the first layer comprises of a mesh so as to enable permeability of moisture and vapour.

Preferably, the second layer comprises of a mesh so as to enable permeability of moisture and vapour.

Preferably, the abrasion resistant material comprises at least one outer layer overlaying the first layer.

Preferably, the outer layer comprises of a flexible textile material.

Preferably, the outer layer comprises of a flexible polymeric material.

Preferably, the abrasian resistant material is a synergistic combination of the at least a first layer; a plurality of abrasion members dispersed throughout the first layer; and the at least a second layer underlying the first layer, the second layer having substantially high tensile and burst strength;

Preferably, the method of construction of an abrasion resistant material comprising the steps of:
selecting a first layer of material, the first layer having a plurality of abrasion members dispersed throughout the first layer;
selecting a second layer of material, the second layer having substantially high tensile and burst strength; and
bonding the first and second layers together,
   wherein the abrasion resistant material is exposed to an abrasive surface and force, the plurality of abrasion members of the first layer are adapted to engage with the abrasive surface and absorb the abrasive force, thereby minimizing exposure of the second layer to the abrasive surface and force and increasing resistance of the abrasion resistant material to tensile or burst failure.

The term “terry”, “terry loop” or “terry knit” refers to a material, either woven or knitted, that has large elongate loops of material extensing outwards from a surface to the material.

### BRIEF DESCRIPTION OF THE DRAWINGS

For a better understanding of the present invention and associated method of use, it will now be described with respect to the preferred embodiment which shall be described herein with reference to the accompanying drawings wherein:

FIG. 1 is a schematic view illustrating an embodiment of the abrasion resistant material;

FIG. 2A to 2C illustrate a woven, jersey knitted and knitted loop pile structures of a first layer of the abrasion resistant material and a comparison of the plurality of abrasion members of the first layer with the abrasion contact points superimposed;

FIG. 3 is a schematic view illustrating a further embodiment of the abrasion resistant material;

FIG. 4 is a schematic view illustrating a method of attachment of the first and second layers of the abrasion resistant material;

FIG. 5 is a schematic view illustrating a further method of attachment of the first and second layers of the abrasion resistant material;

FIG. 6 is a schematic view illustrating a further alternative method of attachment of the first and second layers of the abrasion resistant material; and

FIG. 7 is a schematic view illustrating an embodiment of the abrasion resistant material further comprising an additional layer.

### DETAILED DESCRIPTION OF THE INVENTION

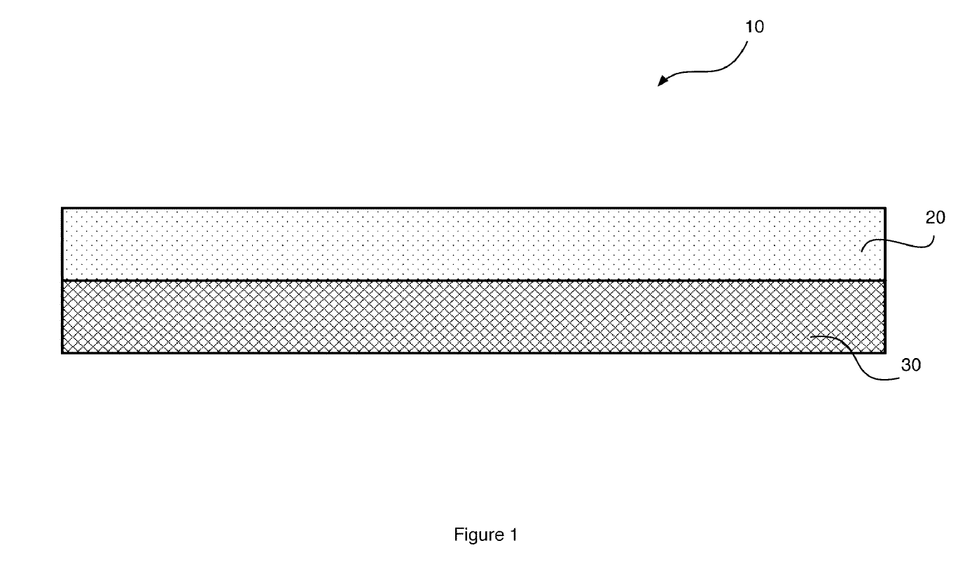

Referring to FIG. 1, there is illustrated one embodiment of an abrasion resistant material 10 for use in the fabrication of protective apparel. The abrasion resistant material 10 is intended to provide a means of protection for a wearer against injury from an abrasive force such as that experienced during sliding along a road surface.

The abrasion resistant material 10 is formed of at least two layers: a first layer 20 and a second layer 30, wherein the first layer 20 is the layer that is exposed to and engages with the abrasive surface, such as a road surface. The second layer 30 comprises of substantially high tensile and burst strength so as to act as a protective layer which covers or at least located closest to the skin of the wearer.

The first layer 20 is adapted to absorb the abrasive force and energy of the initial impact and minimize the exposure of the second layer 30 to the abrasive surface without significantly reducing the structural integrity of the second layer 30 and thereby increasing the resistance of abrasion resistant material 10 to failure such as bursting, tearing, ripping and/or shearing during abrasion and protecting the wearer from significant injury. The interaction of the first layer 20 with the abrasive surface on the initial impact is particularly significant as it enables the first layer 20 to be exposed to and distribute the bulk of the abrasive force and thereby minimise the exposure of the second layer to the abrasive force. This interaction is achieved via the first layer 20 comprising of a plurality of abrasion members 40 dispersed throughout the first layer 20. The plurality of abrasion members 40 serve to absorb the bulk of the abrasion force when the abrasion resistant material 10 is exposed to an abrasive surface.

The plurality of abrasion members 40 of the first layer 20 protrude outwardly from the substantially flat plane of the first layer 20 to form the abrasion resistant first layer 20. Accordingly, on exposure to the abrasive force, the plurality of abrasion members 40 are adapted to degrade so as to minimises the exposure and degradation of the second layer 30. As the second layer 30 maintains sufficient structural integrity, overall the resistance of the abrasion resistant material 10 to tensile and burst failure is increased and serves to protect the wearer from significant injury.

To assist the resistance of the abrasion resistant material 10 to tensile and burst failure, the second layer 30 is formed of a material boasting a substantially high tensile and burst strength.

The first 20 and second 30 layers of the abrasion resistant material 10 can comprise of a flexible textile material, having substantially high tensile and burst strength, including but not limited to polyester, poly amines, polypropylene, polyethylene (including low density, high density and ultra high molecular weight), aramids (para and meta aramids) for example, Kevlal® or Twaron®, liquid crystal polymers, polybenzoxazole (PBO).

Advantageously, the first 20 and second 30 layers being of flexibile and pliable material enhances the versatility of the abrasion resistant material 10 in the manufacture of various types of clothing and apparel, including but not limited to protective apparel for motorcyclists and cyclists. Also, the flexbility of the abrasion resistant material 10 promotes a significant degree of comfort for the wearer, whereby the movement of the wearer is not substantially limited compared to that of conventional materials that are often particularly stiff or thick.

Additionally, the first 20 and second 30 layers may be formed of a mesh. The mesh configuration assists to promote the breathability of the abrasion resistant material 10 such that there is a degree of permeability within the abrasion resistant material 10 for moisture and vapour. The breathability of the abrasion resistant material 10 assists to promote comfort to the wearer.

A non-woven textile material could be used as a component of the first 20 and second 30 layers. The abrasion resistance of a non-woven textile material is moderate as the amount of surface fibres involved in abrasion is moderate.

The plurality of abrasion members 40 may comprise of a plurality of fibres, such as individual fibres, dispersed throughout the first layer 20, arranged in such a manner that a portion of the plurality of fibres protrudes from the substantially flat plane of the first layer 20 so as to be exposed to the abrasive surface and force.

Preferably, the plurality of abrasion members 40 comprise of fibres selected from the group consisting of woven fibres, looped fibres, knitted fibres, non-woven fibres and combinations thereof. It has been found that the configuration of woven fibres, looped fibres, knitted fibres, non-woven and combinations thereof, provides a greater surface area and increases the interaction of the plurality of abrasion members 40 with the abrasion surface. The greater surface area of the woven fibres, looped fibres, knitted fibres and combinations thereof, assist to distribute the abrasion force and load. Effectively, as the pressure distribution is over a larger surface area, the amount of abrasion force per fibre is lower resulting in a slower abrasion of the first layer 20 of the abrasion resistant material 10.

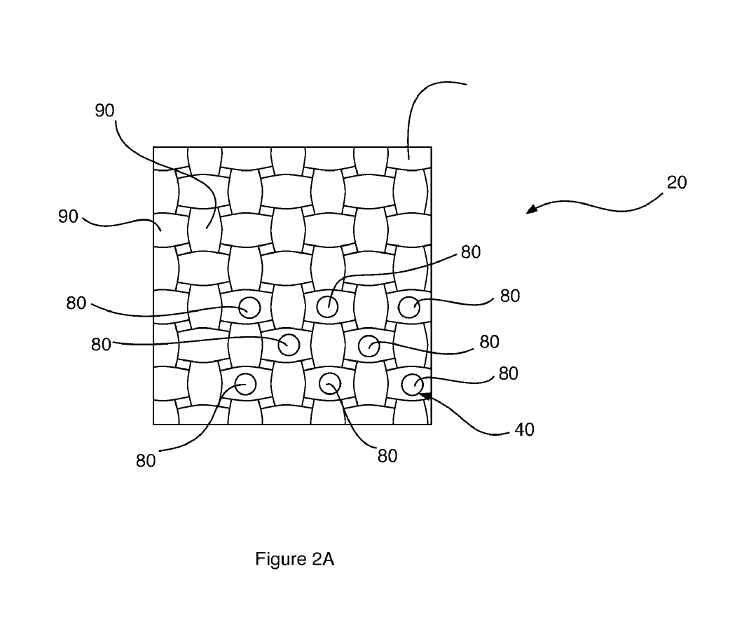

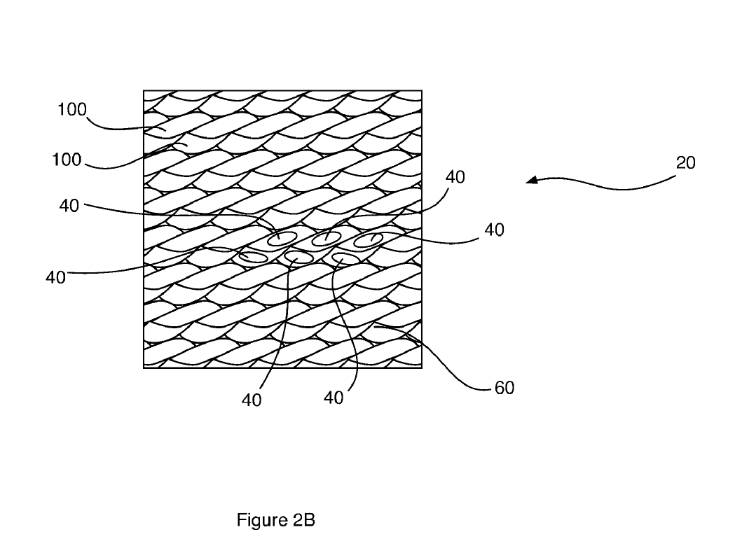

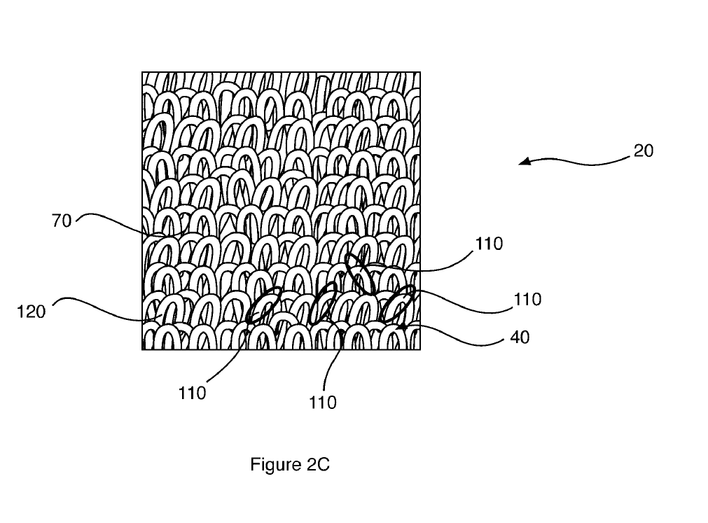

With reference to FIG. 2A to 2C, there is illustrated differing configurations of the plurality of abrasion members 40 dispersed throughout the first layer 20, wherein FIG. 2A illustrates the plurality of abrasion members 40 formed from a woven configuration 50, FIG. 2B illustrates the plurality of abrasion members 40 formed from a jersey knitted configuration 60 and FIG. 2C illustrates the plurality of abrasion members 40 formed from a knitted loop pile configuration 70. The plurality of abrasion members 40 are illustrated with the abrasion contact points superimposed thereon. FIG. 2A to 2C illustrate the comparison of the various configurations of the plurality of abrasion members 40 dispersed within the first layer 20 and in particular the differing configurations and interaction of the plurality of abrasion members 40 disposed therein with an abrasive surface and force.

Referring to FIG. 2A, there is illustrated the interaction of the first layer 20 having a plurality of abrasion members 40 formed from the woven configuration 50, with an abrasion surface. The woven configuration 50 is not a particularly suitable arrangement or structure of the plurality of abrasion members 40, as initial contact with an abrasion surface initiates point loading of the plurality of abrasion members 40, that is where they arc around the perpendicular yarn. The plurality of abrasion members 40 could be described as the peaks 80 of the first layer 20, which protude outwardly from the substantially flat plane of the first layer 20.

The distal tips of the peaks 80 of the woven configuration 50 are exposed to and come into contact with the abrasion surface during initial contact causing high loading on the individual fibres 90 forming the peaks 80 as the ratio of peak area to valley area is small. Once a percentage of the peak 80 is abraded away, the strength of the individual fibres 90 and subsequent strength of the first layer 20 is compromised resulting in fabric failure via tear or burst. Accordingly, this woven configuration 50 is not well suited but can be used as a part of the two layer technology.

FIG. 2B illustrates the interaction of the first layer 20, wherein the plurality of abrasion members 40 are formed of a jersey knitted configuration 60, with an abrasion surface. The jersey knitted configuration 60 provides a better structure for the plurality of abrasion members 40, as initial contact with an abrasion surface involves long lengths of the individual fibres 100 forming the plurality of abrasion members 40 interacting with the abrasion surface. The distribution of the abrasion force and energy is spread over a larger surface area and the amount of abrasion force subjected on each individual fibre 100 is lower resulting in a slower abrasion removal of the plurality of abrasion members 40. Accordingly, the jersey knitted configuration 60 of the first layer 20 is particularly suitable for use in the abrasion resistant material 10.

It would be readily appreciated that the knitted jersey configuration illustrated in FIG. 2B is not just limited to jersey but can be achieved with any other form of knit structure that has surface structure capable of distributing the abrasion load for example, including but not limited to ribs, piques, and many other known knit structures.

Referring now to FIG. 2C, where there is illustrated the interaction of the first layer 20, wherein the plurality of abrasion members 40 are formed of of the knitted loop pile configuration 70, with an abrasion surface. The knitted loop pile configuration 70 is the best structure for the plurality of abrasion members 40, as initial contact with an abrasion surface lays over the loop structure 110. The loop structure 110 provides a further increased surface area wherein longer lengths of individual fibres 120 forming the plurality of abrasion members 40 interacts with the abrasion surface and distribution of the abrasion force is greater.

In particular, the plurality of abrasion members 40 having a smaller loop width and high loop volume, provides better abrasion resistance compared to a larger loop width and/or a low loop volume, as there are more loop structures 110 to interact with the abrasion surface and distribute the abrasion load. The first layer 20 having a plurality of abrasion members 40 formed of the knitted loop pile configuration 70 is very suited to abrasion resistance and is a two layer structure in its own right. The knitted loop pile configuration 70 could also include but not limited to, a woven terry fabric or as a loop pile or cut pile tufted knitted, woven or non woven fabric.

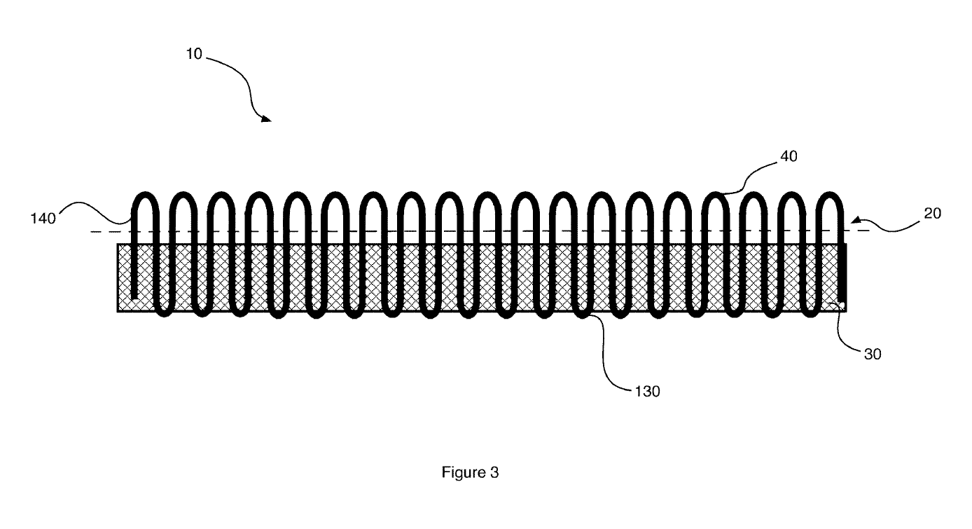

FIG. 3 illustrates a further embodiment of the abrasion resistant material 10, where the first layer 20 is achieved by a loop yarn 130 that passes through the second layer 30. The first layer 20 is effectively formed of a loop pile 140 with the loop structure of the loop pile 140 forming the plurality of abrasion members 40. It would be readily appreciated that the loop yarn 130 could remain as a loop pile 140 as illustrated or could be cut to form a cut pile fabric. The loop yarn 130 is anchored in the second layer 30 to prevent the fibres forming the loop yarn 130 from being pulled out when the abrasion resistant material 10 is subjected to an abrasion force.

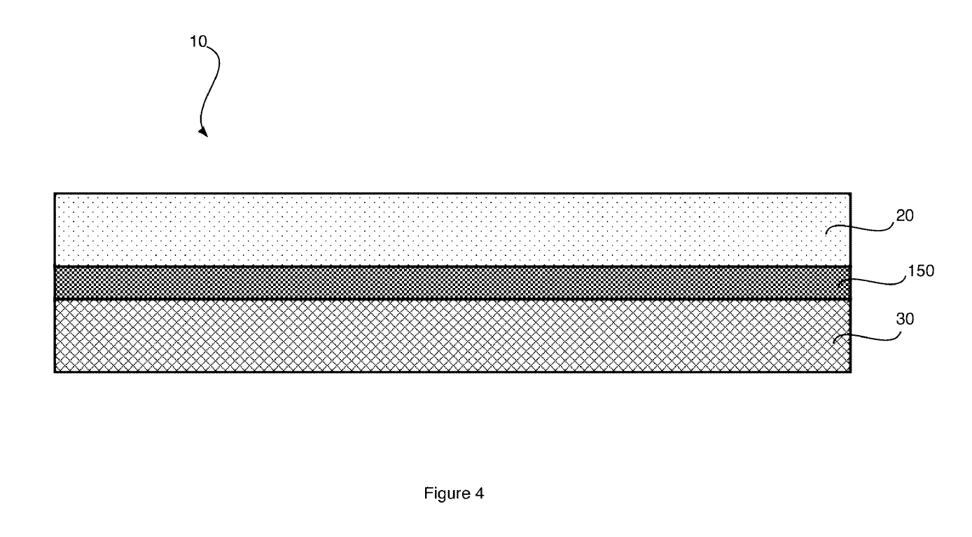

FIG. 4 illustrates a further embodiment of the abrasion resistant material 10 where the method of attachment of the first layer 20 to the second layer 30 is achieved by adhesion of the first 20 and second 30 layers by an adhesive means 150. It would be readily appreciated that any suitable adhesive means 150 known within the art may be utilized including but not limited to acrylates, urethanes, polyesters, esters, butyl rubber.

Alternativelty, the first 20 and second 30 layers may be chemically or thermally bonded to one another using any suitable means known within the art including but not limited toepoxies, melt polymer films, meltable membranes, meltable fibres, meltable sheath core/sheath fibres.

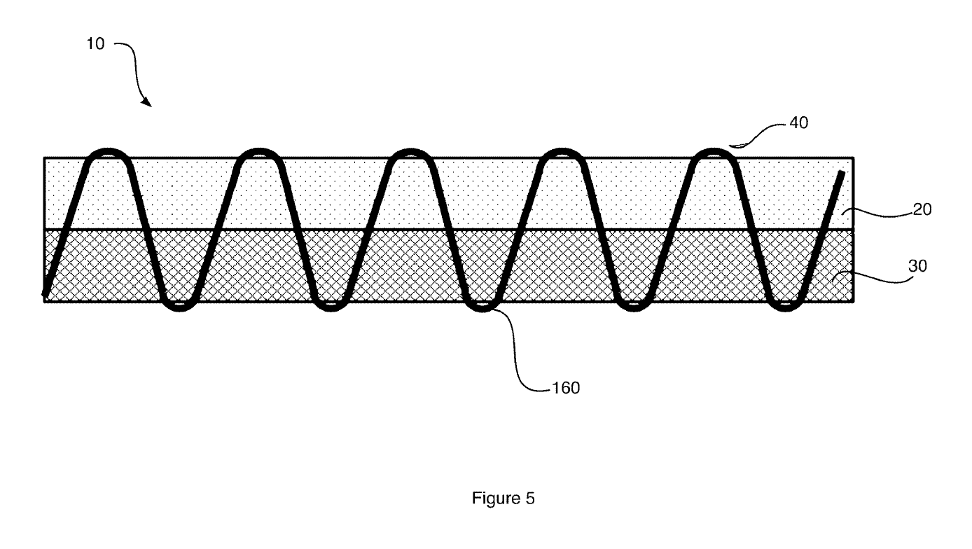

FIG. 5 illustrates a further embodiment of the abrasion resistant material 10 where the method of attachment of the first layer 20 to the second layer 30 is achieved by an independent interlocking thread 160 or a plurality of interlocking threads, that are sewn through the first 20 and second 30 layers. The interlocking thread 160 illustrated in FIG. 5, is shown has having one geometry but it would be readily appreciated that any suitable geometry may be used in the attachment of the first layer 20 to the second layer 30.

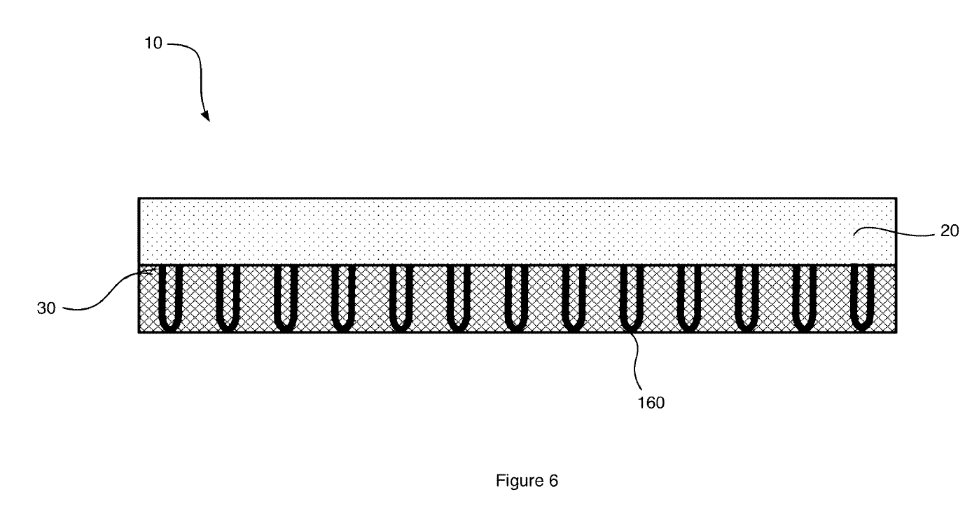

FIG. 6 illustrates a further embodiment of the abrasion resistant material 10 where the method of attachment of the first layer 20 to the second layer 30 is achieved by an interlocking thread 170 that is part of the knitted or woven structure of the first layer 20.

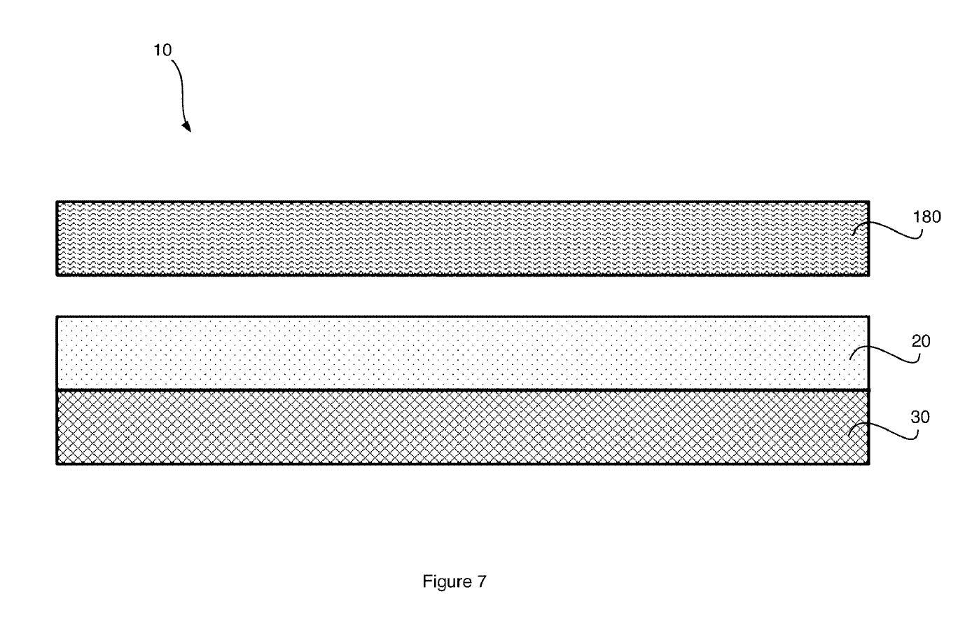

FIG. 7 illustrates a further embodiment of the abrasion resistant material 10 in combination with at least one additional layer 180, in the illustrated embodiment the additional layer 180 overlays the first 20 and second 30 layers It would be readily appreciated that any number of additional layers 180 may be used in conjunction with the abrasion resistant material 10.

Wherein the additional layer 180 overlay the first layer 20 it serves to resist the initial impact force reducing the force transferred to the first 20 and second 30 layers. The additional layer 180 would possess sufficient structural strength and resistance to impact abrasion induced failure including but not limited to tearing, bursting, ripping, tensile failure and shear failure either by the abrasion resistant material 10 itself or by the abrasion resistant material 10 in combination with additional layer 180.

The additional layer 180 can be formed of one or more textile, polymer or leather layers, or combinations thereof.

The following test examples illustrate the present invention. They are presented for illustrative purposes only, and should not be construed as limiting the invention in any way.

### Example 1

This example illustrates the benefit that a correctly designed first layer provides in avoiding burst failure or the underlying second layer. A 230 g/m²double jersey 100% para-aramid fabric is placed under a 350 g/m² 100% cotton denim fabric to form a composite abrasion resistant material. When tested for abrasion resistance according to EN 13634:2010, the composite abrasion resistant material has a mean abrasion resistance of 4.01 and a standard deviation of 0.42 seconds.

The same 230 g/m² double jersey 100% para-aramid fabric is placed under a under a 420 g/m² knitted unbrushed fleecy loop pile 100% cotton fabric to make a composite composite abrasion resistant material. When tested for abrasion resistance according to EN 13634:2010, the composite abrasion resistant material has a mean abrasion resistance of 1.06 and a standard deviation of 0.23 seconds. The double jersey 100% para-aramid fabric is protected from bursting by the 100% cotton denim fabric so failure is by abrasion where the stretch of the knitted unbrushed fleecy loop pile outer fabric allows for stretch to occur in the double jersey 100% para-aramid fabric causing bursting and then rapid failure in abrasion.

### Example 2

This example illustrates the synergistic effect of the first and second layers forming the abrasion resistant material, wherein the first and second layers combine to provide higher abrasion resistance compared to the addition of the abrasion resistance of each of the first and second layers tested by itself.

In the first part of this experiment a 350 g/m² 100% cotton denim fabric has a mean abrasion resistance of 0.41 and a standard deviation of 0.07 seconds and fails due to abrasion fatigue. A 400 g/m² knitted terry loop pile 80% para-aramid/20% ultra high molecular weight polyethylene fabric has a mean abrasion resistance of 1.72 and a standard deviation of 1.13 seconds and fails due to a combination of fabric burst and abrasion fatigue.

A composite combination of these two fabrics with the 100% cotton denim fabric in contact with the abrasion surface and the knitted terry loop pile 80% para-aramid/20% ultra high molecular weight polyethylene fabric in contact with the skin has an abrasion resistance of 8.07 and a standard deviation of 1.01 seconds and fails due to abrasion fatigue. This result is over three times larger than the sum of the individual abrasion resistances of each fabric. This increased abrasion resistance is because the 100% cotton denim layer protects the composite structure from fabric burst.

This same effect is seen with different protective layers and in the second part of this experiment a 300 g/m² 100% cotton denim cargo fabric that had a mean abrasion resistance of 0.30 and a standard deviation of 0.04 seconds and fails due to abrasion fatigue. A 430 g/m² knitted unbrushed fleecy loop pile 80% para-aramid/20% ultra high molecular weight polyethylene fabric had a mean abrasion resistance of 1.89 and a standard deviation of 0.20 seconds and fails due to a combination of fabric burst and abrasion fatigue. A composite combination of these two fabrics with the 100% cotton denim cargo fabric in contact with the abrasion surface and the knitted unbrushed fleecy loop pile 80% para-aramid/20% ultra high molecular weight polyethylene fabric in contact with the skin had an abrasion resistance of 4.72 and a standard deviation of 0.57 seconds and fails due to abrasion fatigue. This result is over twice as large as the sum of the two individual abrasion resistances.

### Example 3

This example illustrates the benefit that a correctly designed abrasion resistant material provides in avoiding abrasion failure. Specifically this example shows the benefit of a well designed composite abrasion resistant material. All of the abrasion resistant materials tested in this example were tested for abrasion resistance according to EN 13634:2010. Each abrasion resistant material was tested having the same first layer which was a 470 g/m² 100% cotton denim fabric that had a mean abrasion resistance of 0.85 and a standard deviation of 0.19 seconds. This first layer was utilized in all tests to avoid bursting of the underlaying second layer influencing the results.

A single layer protective liner such as a 260 g/m² 100% para-aramid plain weave fabric had a mean abrasion resistance of 1.96 and a standard deviation of 0.30 seconds and failed due to abrasion. The protective layer wears through absorbing energy but because it is only a single layer it fails by burst or tearing once a proportion of the protective fibres are worn away. This results in a very low abrasion resistance time. This failure mechanism is the same for a single layer 280 g/m2 100% para-aramid twill weave fabric. It had a mean abrasion resistance of 2.03 and a standard deviation of 0.09 seconds and failed due to abrasion.

A double layer protective liner such as a 330 g/m² 100% para-aramid knitted double jersey fabric had a mean abrasion resistance of 3.75 and a standard deviation of 0.56 seconds and failed due to abrasion. The protective fabric layer wears through absorbing energy and the double layer structure increases the abrasion time as one side of the double layer structure can significantly abrade and absorb energy without failing by burst or tearing. The abrasion resistance result is better than a single layer fabric however the double jersey knit structure means that some of the face yarns are present in the back and some of the back yarns are present in the face compromising the fabric integrity when abraded. This fabric would perform better if the abrasion face had no interlocking yarns present from the back layer of the fabric. This failure mechanism is the same for a single layer 340 g/m² 100% para-aramid knitted double jersey fabric. It had a mean abrasion resistance of 4.01 and a standard deviation of 0.42 seconds and failed due to abrasion.

A double layer protective liner such as a 400 g/m² 100% para-aramid terry loop knitted fabric had a mean abrasion resistance of 8.07 and a standard deviation of 1.01 seconds and failed due to abrasion. The loop structure engages with the abrasion surface first and absorbs energy as it is worn away. Once the end of the loop is broken the number of fibres in the now exposed ends of the loop yarns increase the area of interaction with the abrasion surface. This engages far more fabric surface area with the abrasion surface absorbing more abrasion energy and reducing the force on each individual fibre. As the loop yarn is totally independent of the back fabric strength it abrades away without causing fabric bursting or tearing. This loop interaction with the abrasion surface provides a significant increase in abrasion time to failure. This failure mechanism is the same for a single layer 430 g/m² 100% para-aramid unbrushed fleecy loop knitted fabric. It had a mean abrasion resistance of 5.70 and a standard deviation of 0.11 seconds and failed due to abrasion.

### Example 4

This example illustrates the benefit that an additional layer provides in avoiding premature failure of the inner protective layer. A 400 g/m² terry knit 100% para-aramid fabric is placed under a under a 420 g/m² knitted unbrushed fleecy loop pile 100% cotton fabric to make a two piece composite fabric. When tested for abrasion resistance according to EN 13634:2010 the composite fabric has a mean abrasion resistance of 3.12 and a standard deviation of 0.63 seconds. When the same 400 g/m² terry knit 100% para-aramid fabric is placed under a under 100 g/m2 woven twill 100% cotton fabric in combination with the 420 g/m² knitted unbrushed fleecy loop pile 100% cotton fabric to make a three piece composite fabric it has a mean abrasion resistance of 4.63 and a standard deviation of 0.16 seconds. Without the twill fabric present the 100% cotton unbrushed fleecy fabric bursts placing the protective layer under high impact abrasion loads causing premature failure with a high level of variation. When the twill fabric is present the 100% cotton unbrushed fleecy fabric still bursts on impact however the 100% cotton woven twill fabric remains intact and reduces the initial impact abrasion load on the protective layer and results in a higher and more consistent resistance to abrasion result.

Although the invention has been herein shown and described in what is conceived to be the most practical and preferred embodiment, it is recognized that departures can be made within the scope of the invention, which is not to be limited to the details described herein but it is to be accorded the full scope of the appended claims so as to embrace any and all equivalent devices and apparatus.

1. An abrasion resistant material for use in the fabrication of protective apparel comprising:
at least a first layer;
a plurality of abrasion members dispersed throughout the first layer;
at least a second layer underlying the first layer, the second layer having substantially high tensile and burst strength;
wherein the abrasion resistant material is exposed to an abrasive surface and force, the plurality of abrasion members of the first layer are adapted to engage with the abrasive surface and absorb the abrasive force, thereby minimizing exposure of the second layer to the abrasive surface and force and increasing resistance of the abrasion resistant material to tensile and burst failure.

2. The abrasion resistant material according to claim 1, wherein the plurality of abrasion members protrude beyond a substantially flat plane of the first layer.

3. The abrasion resistant material according to claim 1, wherein the plurality of abrasion members comprise of a plurality of fibres dispersed throughout the first layer.

4. The abrasion resistant material according to claim 1, wherein the plurality of abrasion members comprise of fibres selected from the group consisting of woven fibres, looped fibres, knitted fibres and combinations thereof

5. The abrasion resistant material according to claim 1, wherein the first layer is interconnected with the second layer.

6. The abrasion resistant material according to claim 5, wherein the first layer is interconnected with the second layer by a woven means comprising at least one interlocking thread passing through both the first and second layers.

7. The abrasion resistant material according to any one of claim 1, wherein the first and second layers are interconnected by an adhesive means.

8. The abrasion resistant material according to claim 1, wherein the first and second layers are chemically bonded.

9. The abrasion resistant material according to claim 1, wherein the first and second layer are thermally bonded.

10. The abrasion resistant material according to claim 1, wherein the first layer comprises a flexible textile material.

11. The abrasion resistant material according to claim 1, wherein the second layer comprises a flexible textile material.

12. The abrasion resistant material according to claim 1, wherein the first layer comprises a mesh so as to enable permeability of moisture and vapour.

13. The abrasion resistant material according to claim 1, wherein the second layer comprises a mesh so as to enable permeability of moisture and vapour.

14. The abrasion resistant material according to claim 1, wherein the abrasion resistant material comprises at least one outer layer overlaying the first layer.

15. The abrasion resistant material according to claim 14, wherein the outer layer comprises of a flexible textile material.

16. The abrasion resistant material according to claim 14, wherein the outer layer comprises a flexible polymeric material.

17. A method of construction of an abrasion resistant material according to claim 1, wherein the method comprises the steps of:
a. selecting a first layer of material, the first layer having a plurality of abrasion members dispersed throughout the first layer;
b. selecting a second layer of material, the second layer having substantially high tensile and burst strength;
c. bonding the first and second layers together; and
wherein the abrasion resistant material is exposed to an abrasive surface and force, the plurality of abrasion members of the first layer are adapted to engage with the abrasive surface and absorb the abrasive force, thereby minimizing exposure of the second layer to the abrasive surface and force and increasing resistance of the abrasion resistant material to tensile and burst failure.

18. The abrasian resistant material of claim 1, wherein the combination of the at least a first layer; a plurality of abrasion members dispersed throughout the first layer; at least a second layer underlying the first layer, the second layer having substantially high tensile and burst strength, is a synergistic combination.
